(19) United States
(12) Patent Application Publication
(10) Pub. No.: US 2007/0148498 A1
(43) Pub. Date: Jun. 28, 2007

(54) COATING MATERIALS FOR A CUTTING TOOL / AN ABRASION RESISTANCE TOOL

(76) Inventors: Geun-Woo PARK, Cheong-Ju City (KR); Chang-Gyu Hwang, Cheong-Ju City (KR); Yong-Hee Choi, Cheong-Ju City (KR)

Correspondence Address: IPLA P.A., 3580 WILSHIRE BLVD., 17TH FLOOR, LOS ANGELES, CA, 90010, US

(21) Appl. No.: 11/556,669

(22) Filed: Nov. 3, 2006

(30) Foreign Application Priority Data
Dec. 23, 2005 (KR) 10-2005-0128971

(51) Int. Cl. B32B 9/00; B32B 19/00

(52) U.S. Cl. 428/701; 428/702; 428/698

(57) ABSTRACT

Disclosed herein is an α-Al₂O₃ coating layer, which is applied on the surface of a cutting tool substrate made of cemented carbide, cermet or ceramic material. The α-Al₂O₃ layer is deposited on a TiMewCxNyOz (Me=Zr, Hf, w+x+y+z=1, w, x, y, z≧0) layer to a thickness of 2-1 5 μm through high-temperature chemical vapor deposition, such that the texture coefficient, TC(110), of the crystal plane (110) among the crystal planes (012), (104), (110), (113), (024) and (116) thereof is larger than 1.5, while the texture coefficient of the crystal planes (012), (104), (113), (024) and (116) is smaller than 1.0, said α-Al₂O₃ layer having thermal cracks. Thus, the α-Al₂O₃ layer has improved abrasion resistance and adhesion.

### CROSS REFERENCE

Applicant claims foreign priority under Paris Convention and 35 U.S.C. §119 to the Korean Patent Application No. 10-2005-0128971, filed Dec. 23, 2005 with the Korean Intellectual Property Office.

### BACKGROUND OF THE INVENTION

1. Technical Field

The present invention relates to a coating layer for coated cemented carbides for use in cutting tools such as an indexable insert, and more particularly to a hard ceramic layer having improved abrasion resistance, which serves to improve abrasion resistance of cutting tools, as well as a cutting tool coated with said hard ceramic layer.

2. Description of the Prior Art

To increase the useful life cycle of cutting tools, hard ceramic coating layers by chemical vapor deposition process such as titanium carbide (hereinafter, referred to as TiC), titanium nitride (hereinafter, referred to as TiN), titanium carbon nitride (hereinafter, referred to as TiCN) and alumina (hereinafter, referred to as Al₂O₃) are generally applied on the surfaces of cemented carbide substrates. Among coated cutting tools using Al₂O₃, a cutting tool obtained by applying an Al₂O₃ layer having a thickness of 0.5-1.0 μm on a TiC layer in the year 1973 is regarded as the first in the world. The cutting tool having Al₂O₃ applied on TiC had slightly reduced toughness, but greatly increased abrasion resistance, compared to a monolayer TiC film.

Also, to increase the toughness of cutting tools, a TiCN layer is used, which is coated using an organic CN compound precursor (acetonitrile, CH₃CN) by moderate-temperature chemical vapor deposition (hereinafter, referred to as “MT-CVD”) at 800-900° C. In a high-temperature vapor deposition process (hereinafter, referred to as “HT-CVD”), the conventional TiCN layer was coated using gaseous materials, including TiCl₄, CH₄, N₂ and H₂, at a temperature of about 1,000-1,050° C. Conversely, in the MT-CVD process, the TiCN layer was coated using TiCl₄, CH₃CN, N₂, H₂ and the like at a temperature of 800-900° C. The TiCN layer coated using the MT-CVD process has a layer hardness, which is slightly lower than that of the TiC layer, but is sufficient to increase the abrasion resistance of cemented carbides. Also, the TiCN layer has columnar crystal structure and thus excellent toughness.

In the case of Al₂O₃ layers having excellent oxidation resistance, since it was reported in studies on phase control technology for Al₂O₃ layers in the 1980s that alpha-alumina (hereinafter, referred to as α-Al₂O₃) and kappa-alumina (hereinafter, referred to as K-Al₂O₃) layers are suitable for cast iron and steel, respectively, the control technology for Al₂O₃ layers has been rapidly developed and commercialized. Among Al₂O₃ phases, α-Al₂O₃ is a unique stable phase, which does not have any change during its processing, and has the highest hardness. Thus, it shows excellent cutting performance in cast iron processing under high-speed cutting conditions. On the other hand, the K-Al₂O₃ layer has thermal conductivity lower than that of α-Al₂O₃, and thus exhibits excellent abrasion resistance in a steel cutting process, which generates a lot of heat.

To increase abrasion resistance in cast iron turning, various methods for controlling the preferred orientation on the crystal plane of α-Al₂O₃ layers are known.

European Patent Publication No. 603144 discloses a method for forming an α-Al₂O₃ layer having a preferred crystal growth orientation on the plane (012), the method comprising the first step of supplying CO₂, CO, AlCl₃ and H₂ gases, and the second step of supplying CO₂, AlCl₃, H₂S and H₂ gases, realizing a preferred crystal growth orientation on the plane (012). European Patent Publication No. 659903 discloses a method for forming an α-Al₂O₃ layer, having a preferred crystal growth orientation on the plane (110) and being free of thermal cracks, the method comprising the first step of supplying CO₂, HCl, AlCl₃ and H₂ gases and the second step of supplying CO₂, AlCl₃, SF₆, HCl and H₂ gases. U.S. Pat. No. 5,766,782 discloses a method for forming an α-Al₂O₃ layer having a preferred crystal growth orientation on the plane (104), the method comprising the first step of supplying CO₂, CO, HCl, AlCl₃ and H₂ gases and the second step of supplying CO₂, AlCl₃, HCl, H₂S and H₂ gases. US Patent Publication No. 2002/0155325 discloses a method for forming an α-Al₂O₃ layer comprising the first step of supplying CO₂, AlCl₃, HCl and H₂ gases and a second step of supplying CO₂, AlCl₃, ZrCl₄, HCl, H₂S and H₂ gases.

In addition, European Patent Publication No. 1207216 discloses that, when the thickness of α-Al₂O₃ layers is increased, the preferred plane thereof can be changed to (012), (104) or (116).

However, these patents disclose only the preferred growth of a specific crystal plane among the typical planes (012), (104), (110), (113), (024) and (116) of the α-Al₂O₃ layer, but do not disclose the relationship of the α-Al₂O₃ layer with the remaining crystal planes.

Technical Solution

Accordingly, The object of the present invention is to provide a polycrystalline α-Al₂O₃ coating layer for cutting tools or an abrasion resistant tool, which has excellent cutting ability and a desired crystallographic structure obtained by controlling the nucleation and growth conditions of the α-Al₂O₃ phase, and is deposited on a hard material or TiMewCxNyOz (Me=Zr, Hf, w+x+y+z=1, w, x, y, z≧0) layer.

Another object of the present invention is to provide a cutting tool deposited with an α-Al₂O₃ layer having improved cutting performance for steel, stainless steel, and cast iron, particularly general cast iron and nodular graphite cast iron.

To achieve the above objects, the present invention provides a polycrystalline α-Al₂O₃ coating layer, which is formed on the substrate of a cutting tool or an abrasion resistant tool in such a manner that the texture coefficient, TC (110), of the crystal plane (110) among the crystal planes (012), (104), (110), (113), (024) and (116) of the α-Al₂O₃ layer is larger than 1.5, while the texture coefficient of the crystal planes (012), (104), (113), (024) and (116) is smaller than 1.0. The inventive α-Al₂O₃ layer has thermal cracks. The inventive α-Al₂O₃ layer has a preferred crystal growth orientation on the plane (110), as confirmed by X-ray diffraction (XRD) measurements. The Texture Coefficient (TC) for the α-Al₂O₃ layer is defined as follows:

$$TC ( hkl ) = \frac{I ( hkl )}{{I}_{0} ( hkl )} {\{ \frac{1}{n} \sum \frac{I ( hkl )}{{I}_{0} ( hkl )} \}}^{- 1}$$

wherein I(hkl)=measured diffraction intensity at the plane (hkl); I₀(hkl)=standard diffraction intensity of the ASTM standard powder pattern diffraction data; n=number of crystal planes used in the calculation; and used crystal planes (hkl) are: (012), (104), (110), (113), (024) and (116).

The inventive α-Al₂O₃ layer is preferably deposited on a TiMewCxNyOz (Me=Zr, Hf, w+x+y+z=1, w, x, y, z≧0) layer. The α-Al₂O₃ layer is preferably wet-blasted with α-Al₂O₃ powder having a particle size of 10-300 μm.

In another aspect, the present invention provides a coating material obtained by depositing on the substrate of a cutting tool or an abrasion resistant tool at least one material selected from among nitride, carbide, carbonitride, oxynitride, carbonitride and oxycarbonitride of an IV-A group metal, and carbonitride and oxycarbonitride of an IV-A group metal having a columnar structure, depositing thereon a TiMewCxNyOz (Me=Zr, Hf, w+x+y+z=1, w, x, y, z≧0) layer, and then CVD depositing thereon at least one material selected from the group consisting of Al₂O₃, ZrO₂, HfO₂, Y₂O₃, AlN, cBN and TiB₂.

In the inventive coating material, it is preferable that the phase of Al₂O₃ is an alpha (α) phase, and the Al₂O₃ layer is an α-Al₂O₃ layer, which is formed in such a manner that the texture coefficient, TC (110), of the crystal plane (110) is larger than 1.5, while the texture coefficient of the crystal planes (012), (104), (113), (024) and (116) is smaller than 1.0.

Also, the uppermost coating layer of the surface coating material for tools is preferably formed by either depositing at least one material selected from the group consisting of nitride, carbide, carbonitride, oxynitride, carbonitride and oxycarbonitride of an IV-A group metal, through HT-CVD, or depositing at least one material selected from among carbonitride and oxycarbonitride of an IV-A group metal having a columnar structure, through MT-CVD.

The uppermost coating layer is preferably dry or wet blasted with Al₂O₃ powder to improve the surface roughness thereof.

Thus, according to the present invention, an Al₂O₃ layer is provided, which is applied on the surface of a cutting tool substrate made of cemented carbide, cermet, ceramic or the like. The Al₂O₃ layer is formed in a manner such that the texture coefficient, TC(110), of the crystal plane (110) of the layer is larger than 1.5, while the texture coefficient of the crystal planes (012), (104), (113), (024) and (116) is smaller than 1.0.

In the prior art, a TiCxNyOz (x+y+z=1, x, y, z≧0) layer was applied on the surface of a cemented carbide substrate using TiCl₄, CH₄, H₂, N₂, CO₂ and CO gases by HT-CVD at a temperature of 1000-1100° C. In the present invention, in addition to said layer composition in the prior art, ZrCl₄ and HfCl₄ as sources for metals (Zr and Hf) are additionally used to form a TiMewCxNyOz (Me=Zr, Hf, w+x+y+z=1, w, x, y, z≧0) layer through HT-CVD or MT-CVD. In this case, the TiMewCxNyOz layer is formed to a thickness of 0.1-5 μm, and preferably 0.5-3 μm.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a 3000× magnification scanning microscope (SEM) photograph showing the state in which an α-Al₂O₃ layer was deposited on a TiMewCxNyOz (Me=Zr, Hf, w+x+y+z=1, w, x, y, z≧0) layer formed according to the present invention; and

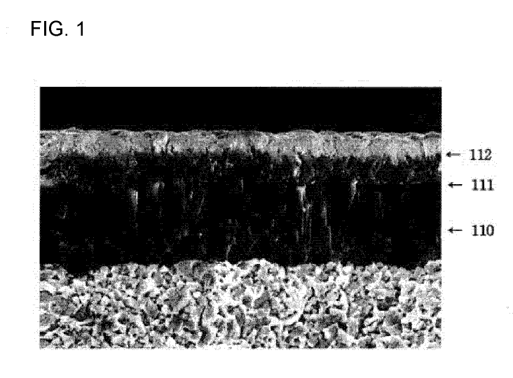

FIG. 2 is a 360× optical microscope photograph showing thermal cracks on the surface of a TiMewCxNyOz (Me=Zr, Hf, w+x+y+z=1, w, x, y, z≧0) layer formed according to the present invention.

### DETAILED DESCRIPTION OF THE INVENTION

Hereinafter, the present invention will be described in further detail with reference to preferred examples. It is to be understood, however, that these examples are for illustrative purposes only, and are not to be construed to limit the scope of the present invention.

### EXAMPLE 1

(A) A TiCN layer having a thickness of 8 μm was deposited on cemented carbide for coated cutting tools corresponding to the ISO K05 grade by MT-CVD, and a 0.5 μm thick TiMewCxNyOz (Me=Zr, Hf, w+x+y+z=1, w, x, y, z≧0) layer according to the present invention was deposited thereon. Then, a 5 μm thick α-Al₂O₃ layer was deposited thereon.

As shown in Table 1 below, X-ray diffraction analysis for the coated material showed that the texture coefficient, TC(100), of the crystal plane (110) of the crystalline α-Al₂O₃ layer was 4.4, and the texture coefficient of the remaining crystal planes was smaller than 1.0.

TABLE 1

| Crystal planes | Texture coefficient (TC) |
|---|---|
| (012) | 0.93 |
| (104) | 0.05 |
| (110) | 4.44 |
| (113) | 0.09 |
| (024) | 0.46 |
| (116) | 0.03 |

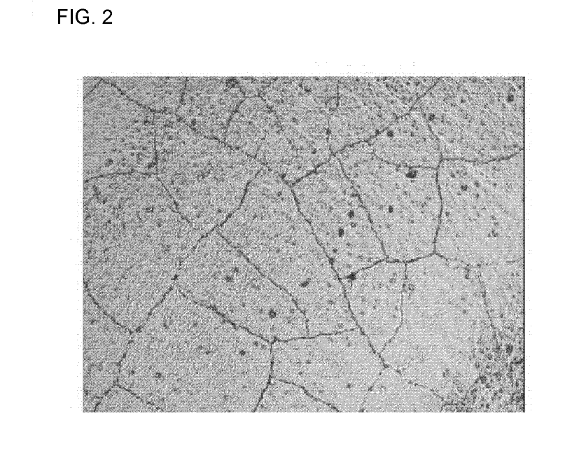

FIG. 2 shows the results of optical microscopy (360× magnification) for the surface of the layer fabricated in the above section (A). As shown in FIG. 2, thermal cracks were present even in the polycrystalline α-Al₂O₃ layer having a preferred crystal growth orientation on the plane (110).

(B) A TiCN layer having a thickness of 10 μm was deposited on cemented carbide for coated cutting tools corresponding to the ISO K05 grade by MT-CVD, and a 0.5 μm thick TiMewCxNyOz (Me=Zr, Hf, w+x+y+z=1, w, x, y, z≧0) layer according to the prior art was deposited thereon. Then, a 5 μm thick α-Al₂O₃ layer was deposited thereon.

As shown in Table 2 below, X-ray diffraction analysis for the coated material showed that the texture coefficient of the crystal planes (012), (104), (110), (024) and (116) of the crystalline α-Al₂O₃ layer was larger than 1.0 and the texture coefficient of the crystal plane (113) was 0.3.

TABLE 2

| Crystal plane | Texture coefficient (TC) |
|---|---|
| (012) | 1.34 |
| (104) | 1.40 |
| (110) | 1.89 |
| (113) | 0.30 |
| (024) | 1.01 |
| (116) | 2.06 |

C) A TiCN layer having a thickness of 8 μm was deposited on cemented carbide for coated cutting tools corresponding to the ISO K05 grade through MT-CVD, and a 4 μm thick K-Al₂O₃ layer was deposited.

The coated cutting tools fabricated in the above sections A), B) and C) were dry or wet blasted with 200-mesh Al₂O₃ powder to improve the surface roughness thereof.

The Al₂O₃ layers (B and C) according to the prior art and the Al₂O₃ layer (A) according to the present invention were measured for the microhardness thereof. The measurements were made using a microhardness meter (Fischerscope H100C XYp; Fischer Technology, Inc.) at a load of 300 mN. As shown in Table 3 below, the hardness values of the Al₂O₃ layers (B and C) formed according to the prior art were 18.5 GPa and 17.6 GPa, respectively, and the hardness of the layer (A) formed according to the present invention was 19.9 GPa, which is higher than those of the Al₂O₃ layers according to the prior art.

TABLE 3

| | Samples | Microhardness (300 mN) |
|---|---|---|
| Invention | A | 19.9 GPa |
| Prior art | B | 18.5 GPa |
| Prior art | C | 17.6 GPa |

The coated cutting tools (B and C) according to the prior art and the coated cutting tool (A) according to the present invention were evaluated for cutting performance by cutting the same workpiece using the cutting tools for the same time of 10 minutes, measuring the flank wear of each of the tools, and analyzing the percentage of the cut edge line that flaked. The evaluation results are shown in Table 4 below. As can be seen in Table 4, the tool (A) according to the present invention was improved with respect to chipping resistance and abrasion resistance compared to the tools (B and C) according to the prior art.

Cutting Test Conditions
Cutting conditions: V=400 m/min, f=0.3 mm/rev, d=2.0 mm, and wet cutting;
Workpiece: Cast iron(AISI/SAE No 35B, DIN-GG25) (300 mm diameter and 600 mm length), and outside cutting;
Tool type: CNMG120408-GR

TABLE 4

| | | Flaking (%) | Tool flank |
|---|---|---|---|
| | Samples | in edge line | wear (mm) |
| Invention | A | 0 | 0.115 |
| Prior art | B | 20 | 0.135 |
| Prior art | C | 50 | 0.178 |

### EXAMPLE 2

(D) A TiCN layer having a thickness of 10 μm was deposited on cemented carbide corresponding to the ISO P10 grade through MT-CVD, and a 0.5 μm thick TiMewCxNyOz (Me=Zr, Hf, w+x+y+z=1, w, x, y, z≧0) layer according to the present invention was deposited thereon. Then, a 5 μm thick α-Al₂O₃ layer was deposited thereon. As shown in Table 5, X-ray diffraction analysis for the Al₂O₃ layer showed that the TC (110) of the (110) crystal plane of the polycrystalline Al₂O₃ layer was 4.96 and the TC of the remaining crystal planes was smaller than 1.0.

TABLE 5

| Crystal planes | Texture coefficient (TC) |
|---|---|
| (012) | 0.53 |
| (104) | 0.01 |
| (110) | 5.06 |
| (113) | 0.11 |
| (024) | 0.28 |
| (116) | 0.01 |

E) A 7 μm thick TiCN layer was deposited on cemented carbide corresponding to the ISO P10 grade by MT-CVD, and a 1.5 μm thick TiC layer and 3 μm thick K-Al₂O₃ layer were sequentially deposited thereon.

The coated cutting tools fabricated in the above sections D) and E) were dry or wet blasted with 200-mesh Al₂O₃ powder to improve the surface roughness thereof.

The coated cutting tool (E) according to the prior art and the coated cutting tool (D) according to the present invention were evaluated for cutting performance by cutting the same workpiece using the cutting tools for the same time period, 30 minutes, measuring the flank wear of each of the tools, and analyzing the percentage of the cut edge line that flaked. The evaluation results are shown in Table 6 below. As can be seen in Table 6, the tool (D) according to the present invention was improved with respect to chipping resistance and abrasion resistance compared to the tool (E) according to the prior art.

Cutting Test Condition
Cutting conditions: V=250 m/min, f=0.25 mm/rev, d=2.0 mm, and wet cutting;
Workpiece: Alloy steel(AISI/SAE-4140, DIN-41 CrMo4) (300 mm diameter and 600 mm length), and outside cutting; and
Tool type: CNMG120408-HM

TABLE 6

| | | Flaking (%) | Tool flank |
|---|---|---|---|
| | Sample | in edge line | wear (mm) |
| Invention | D | 0 | 0.153 |
| Prior art | E | 30 | 0.251 |

As described above, according to the present invention, the TiMewCxNyOz(Me=Zr, Hf, w+x+y+z=1, w, x, y, z≧0) layer is deposited on a cutting tool substrate to a thickness of 0.1-5 μm, and the α-Al₂O₃ layer is deposited thereon to a thickness of 2-15 μm, such that the texture coefficient, TC(110), of the crystal plane (110) among the crystal planes (012), (104), (110), (113), (024) and (116) of the polycrystalline α-Al₂O₃ layer is larger than 1.5, while the texture coefficient of the crystal planes (012), (104), (113), (024) and (116) is smaller than 1.0. Thus, the α-Al₂O₃ layer can be greatly improved with respect to abrasion resistance and adhesion.

Although the preferred embodiment of the present invention has been described for illustrative purposes, those skilled in the art will appreciate that various modifications, additions and substitutions are possible, without departing from the scope and spirit of the invention as disclosed in the accompanying claims.

What is claimed is:

1. A polycrystalline α-Al₂O₃ coating layer for cutting tools or an abrasion resistant tool, which is deposited on a TiMewCxNyOz (Me=Zr, Hf, w+x+y+z=1, w, x, y, z≧0) layer on a cutting tool or an abrasion resistant tool substrate by high-temperature chemical vapor deposition, in a manner such that the texture coefficient, TC(110), of the crystal plane (110) among the crystal planes (012), (104), (110), (113), (024) and (116) of the α-Al₂O₃ coating layer is larger than 1.5, while the texture coefficient of crystal planes (012), (104), (113), (024) and (116) is smaller than 1.0, said α-Al₂O₃ layer having thermal cracks, and said texture coefficient (TC) being defined as follows:
$$TC ( hkl ) = \frac{I ( hkl )}{{I}_{0} ( hkl )} {\{ \frac{1}{n} \sum \frac{I ( hkl )}{{I}_{0} ( hkl )} \}}^{- 1}$$
wherein I(hkl)=measured diffraction intensity at a crystal plane (hkl); I₀(hkl)=standard intensity of ASTM standard powder pattern diffraction data; n=number of crystal planes used in the calculation; and used crystal planes (hkl) are: (012), (104), (110), (113), (024) and (116).

2. The coating layer of claim 1, wherein the α-Al₂O₃ layer is wet blasted with α-Al₂O₃ powder having a particle size of 10-300 μm.

3. A surface coating material for cutting tools or an abrasion resistant tool, which is obtained by depositing on a cutting tool or an abrasion resistant tool substrate at least one material selected from among nitride, carbide, carbonitride, oxynitride, carbonitride and oxycarbonitride of an IV-A group metal, and carbonitride and oxycarbonitride of an IV-A group metal having a columnar structure, depositing thereon a TiMewCxNyOz (Me=Zr, Hf, w+x+y+z=1, w, x, y, z≧0) layer, and then CVD depositing thereon at least one material selected from the group consisting of Al₂O₃, ZrO₂, HfO₂, Y₂O₃, AlN, cBN and TiB₂.

4. The surface coating material of claim 3, wherein the phase of said Al₂O₃ is an alpha (α) phase.

5. The surface coating material of claim 3, wherein said Al₂O₃ layer is a polycrystalline α-Al₂O₃ layer, which is formed in a manner such that the texture coefficient, TC(110), of the crystal plane (110) among the crystal planes (012), (104), (110), (113), (024) and (116) thereof is larger than 1.5, while the texture coefficient of the crystal planes (012), (104), (113), (024) and (116) is smaller than 1.0, said α-Al₂O₃ layer having thermal cracks.
